(19) United States
(12) Patent Application Publication
(10) Pub. No.: US 2004/0099488 A1
(43) Pub. Date: May 27, 2004

(54) Friction brake apparatus

(75) Inventor: Tatsuya Sano, Nissin-shi (JP)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/715,373

(22) Filed: Nov. 19, 2003

(30) Foreign Application Priority Data
Nov. 25, 2002 (JP) 2002-340382

(51) Int. Cl. F16D 55/00

(52) U.S. Cl. 188/71.1

(57) ABSTRACT

A friction brake apparatus includes a rotary member and a friction material, the friction material coming into pressing contact with a friction surface of the rotary member so as to brake the rotary member by means of friction force. A wear-particle-removing device for removing adhering wear particles from the friction surface of the rotary member is provided at least downstream or upstream of an installation position of the friction material with respect to a rotational direction of the rotary member.

### BACKGROUND OF THE INVENTION

1. Field of the Invention

The present invention relates to a friction brake apparatus, such as a disc brake or a drum brake, configured such that a friction material comes into pressing contact with a friction surface of a rotary member so as to brake the rotary member by means of friction force.

2. Description of the Related Art

In a friction brake apparatus of the above-mentioned type, the friction material comes into pressing contact with the friction surface of the rotary member, and the friction material wears and generates wear particles. A portion of the friction particles scatter outward, and a portion of the friction particles remain adhering to the friction surface of the rotary member, which rotates. Japanese Patent Application Laid-Open (kokai) No. 9-257062 discloses a technique for preventing outwardly scattering wear particles from adhering to and smudging a wheel. Japanese Patent No. 2910366 discloses a technique for preventing adhesion of wear particles to the rotary member.

The conventional techniques fail to remove adhering wear particles from the friction surface of the rotary member. Thus, the wear particles reenter a press contact region (friction interface) where the friction material and the friction surface of the rotary member come into pressing contact with each other, potentially causing instability of friction characteristics attained in the press contact region.

### SUMMARY OF THE INVENTION

In view of the foregoing, an object of the present invention is to provide a friction brake apparatus in which adhering wear particles can be removed from a friction surface of a rotary member so as to attain stable friction characteristics in a press contact region where a friction material comes into pressing contact with the friction surface of the rotary member.

In order to achieve the above object, the present invention provides a friction brake apparatus comprising a rotary member and a friction material, the friction material coming into pressing contact with a friction surface of the rotary member so as to brake the rotary member by means of friction force. A wear-particle-removing device for removing adhering wear particles from the friction surface of the rotary member is provided at least downstream or upstream of an installation position of the friction material with respect to a rotational direction of the rotary member.

The thus-provided wear-particle-removing device can remove adhering wear particles from the friction surface of the rotary member, thereby allowing suppression of entry of wear particles into a press contact region (friction interface) where the friction material and the friction surface of the rotary member come into pressing contact with each other, as well as allowing attainment of stable friction characteristics in the press contact region.

Preferably, the wear-particle-removing device is provided in a noncontacting condition in relation to the friction surface of the rotary member. In this case, the wear-particle-removing device can remove adhering wear particles from the friction surface of the rotary member without generation of drag torque.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a schematic side view showing a disc brake according to one embodiment of the present invention;

FIG. 2 is a sectional view taken along line 2-2 of FIG. 1;

FIG. 3 is a sectional view taken along line 3-3 of FIG. 1; and

FIG. 4 is a sectional view corresponding to FIG. 3 and showing a modification of the wear-particle-removing device.

### DESCRIPTION OF THE PREFERRED EMBODIMENT

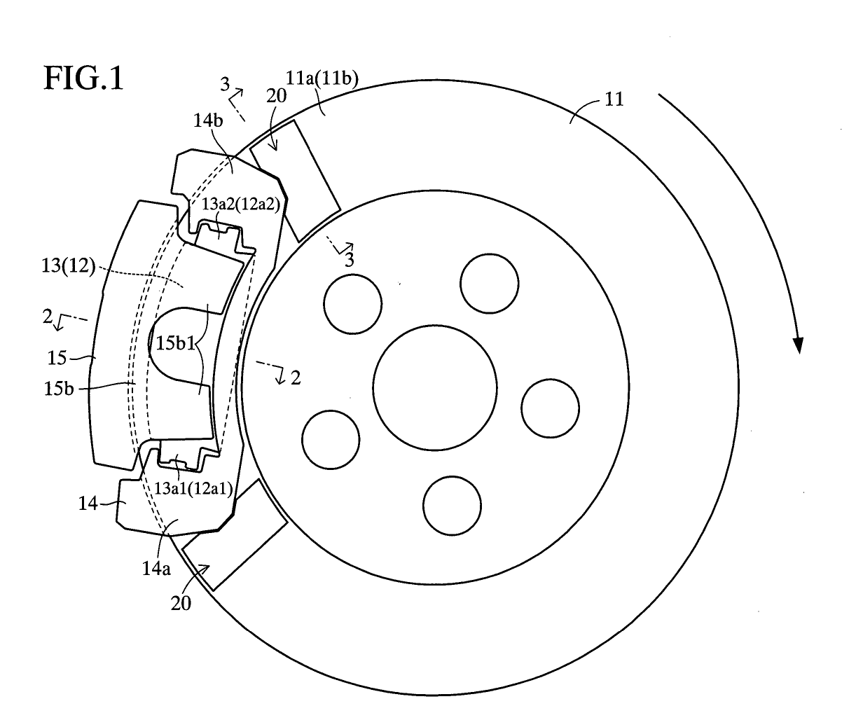

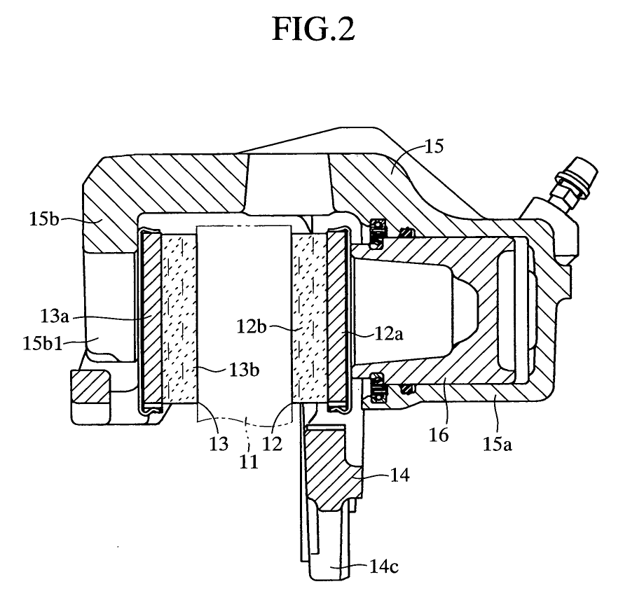

An embodiment of the present invention will now be described with reference to the drawings. FIGS. 1 to 3 show a disc brake for use in a vehicle according to an embodiment of the present invention. In this disc brake, an inner pad 12 and an outer pad 13, which press-hold and brake a disc rotor 11 that serves as a rotary member, are mounted to a mounting 14 so as to be movable over a predetermined distance in the direction of the rotor axis (the left-right direction in FIG. 2). Further, a movable caliper 15 is mounted to the mounting 14 to be movable in the direction of the rotor axis.

As shown in FIG. 2, the inner pad 12 includes a backing plate 12a and a lining (friction material) 12b. As shown in FIG. 1, the inner pad 12 is mounted to torque-receiving portions 14a and 14b of the mounting 14 via corresponding guide plates (not shown), which are mounted to the mounting 14 by means of opposite end lug portions (opposite end portions with respect to the circumferential direction of the disc rotor 11) 12a1 and 12a2 of the backing plate 12a, in such a manner as to be movable in the direction of the rotor axis and to be able to transmit torque.

As shown in FIG. 2, the inner pad 12 is pressed and moved toward the disc rotor 11 by means of a piston 16, which is accommodated in a cylinder portion 15a of the movable caliper 15 to be movable in the direction of the rotor axis.

As shown in FIG. 2, the outer pad 13 includes a backing plate 13a and a lining (friction material) 13b. As shown in FIG. 1, the outer pad 13 is mounted to the torque-receiving portions 14a and 14b of the mounting 14 via the corresponding guide plates, which are mounted to the mounting 14 by means of opposite end lug portions (opposite end portions with respect to the circumferential direction of the disc rotor 11) 13a1 and 13a2 of the backing plate 13a, in such a manner as to be movable in the direction of the rotor axis and to be able to transmit torque.

The outer pad 13 is pressed and moved toward the disc rotor 11 by means of finger-like portions 15b1 of a reaction arm portion 15b of the movable caliper 15, the reaction arm portion 15b being formed to overhang the pads 12 and 13.

The mounting 14 includes, in addition to the torque-receiving portions 14a and 14b for supporting the inner pad 12 and the outer pad 13, a mounting portion (not shown) to which the movable caliper 15 is mounted, and a mounting portion 14c to be mounted to a nonrotational portion (not shown) of a vehicle body.

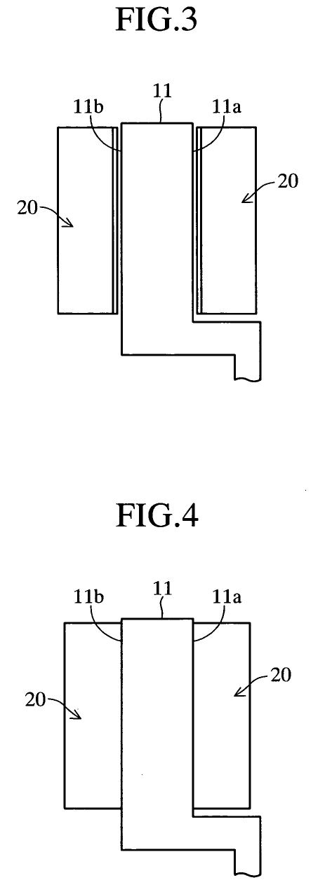

In the present embodiment, as schematically shown in FIGS. 1 and 3, wear-particle-removing devices 20 for removing adhering wear particles (a substance to be generated as a result of wear of the linings (friction material) 12b and 13b) from friction surfaces 11a and 11b of the disc rotor 11 are respectively disposed downstream of and upstream of the installation position of the inner and outer pads 12 and 13 with respect to the rotational direction of the disc rotor 11.

The wear-particle-removing devices 20 are mounted to the mounting 14 in a noncontacting condition in relation to the friction surfaces 11a and 11b of the disc rotor 11. Specifically, the wear-particle-removing devices 20 are of, for example, an electrostatic type (wear particles are positively or negatively charged and removed through electromagnetic suction), a magnetic type (wear particles are of a magnetic material and removed through magnetic suction), a negative pressure type (negative pressure is generated through suction so as to draw out wear particles together with air), a blow type (wear particles are blown off to be removed, by means of blowing), or a physical adhesion type (wear particles are removed through adhesion to an adhesive material).

As schematically shown in FIG. 4, the wear-particle-removing devices 20 may be provided in contact with the friction surfaces 11a and 11b of the disc rotor 11. Alternatively, the wear-particle-removing devices 20 may be provided, in combination, in contact with and in a noncontacting condition in relation to the friction surfaces 11a and 11b of the disc rotor 11.

The disc brake of the present embodiment having the above-described configuration operates as follows. During braking, pressurized oil is supplied to the cylinder portion 15a of the movable caliper 15, whereby the pressurized oil causes the piston 16 to move and press the inner pad 12 toward the disc rotor 11, with generation of a reaction force which causes the finger-like portions 15b1 of the reaction arm portion 15b of the movable caliper 15 to move and press the outer pad 13 toward the disc rotor 11. Therefore, the inner pad 12 and the outer pad 13 are pressed against the disc rotor 11, so that the inner pad 12 and the outer pad 13 press-hold the disc rotor 11 to thereby generate a braking force.

In the disc brake of the present embodiment, the wear-particle-removing devices 20 for removing adhering wear particles from the friction surfaces 11a and 11b of the disc rotor 11 are respectively disposed downstream of and upstream of the installation position of the inner and outer pads 12 and 13 with respect to the rotational direction of the disc rotor 11. Thus, adhering wear particles can be removed from the friction surfaces 11a and 11b of the disc rotor 11.

The thus-provided wear-particle-removing devices 20 allow suppression of entry of wear particles into a press contact region (friction interface) where the friction surfaces 11a and 11b of the disc rotor 11 and the linings (friction material) 12b and 13b of the inner and outer pads 12 and 13 come into pressing contact with each other, as well as allowing stable friction characteristics in the press contact region.

The wear-particle-removing devices 20 are provided in a noncontacting condition in relation to the friction surfaces 11a and 11b of the disc rotor 11. Specifically, the wear-particle-removing devices 20 are of, for example, an electrostatic type, a magnetic type, a negative pressure type, a blow type, or a physical adhesion type, whereby adhering wear particles can be removed from the friction surfaces 11a and 11b of the disc rotor 11 without generation of drag torque.

In the above-described embodiment, the present invention is applied to a disc brake of a movable caliper type. However, the present invention can be applied not only to a disc brake of a stationary caliper type, but also to various friction brake apparatus configured such that a friction material comes into pressing contact with a friction surface of a rotary member so as to brake the-rotary member by means of friction force; for example, to a drum brake.

In the above-described embodiment, the wear-particle-removing devices 20 are respectively disposed downstream of and upstream of the installation position of the inner and outer pads 12 and 13 with respect to the rotational direction of the disc rotor 11. However, the wear-particle-removing device 20 may be disposed either downstream or upstream of the installation position of the inner and outer pads 12 and 13.

In the above-described embodiment, the wear-particle-removing devices 20 are mounted to the mounting 14. However, the wear-particle-removing device 20 may be provided independent of the mounting 14. In this case, since there is no need to provide the wear-particle-removing device 20 in the vicinity of the installation position of the inner and outer pads 12 and 13, the wear-particle-removing device 20 can be provided at any circumferential position of the disc rotor 11.

Obviously, numerous modifications and variations of the present invention are possible in light of the above teachings. It is therefore to be understood that within the scope of the appended claims, the present invention may be practiced otherwise than as specifically described herein.

What is claimed is:

1. A friction brake apparatus comprising a rotary member and a friction material, the friction material coming into pressing contact with a friction surface of the rotary member so as to brake the rotary member by means of friction force, wherein a wear-particle-removing device for removing adhering wear particles from the friction surface of the rotary member is provided at least downstream or upstream of an installation position of the friction material with respect to a rotational direction of the rotary member.

2. A friction brake apparatus according to claim 1, wherein the wear-particle-removing device is provided in a noncontacting condition in relation to the friction surface of the rotary member.
